(19) United States
(12) Patent Application Publication
(10) Pub. No.: US 2018/0001249 A1
(43) Pub. Date: Jan. 4, 2018

(54) Methods Apparatuses Assemblies Devices and Systems for Conditioning and Purifying Air

(71) Applicant: Abe M. Sher, Surfside, FL (US)

(72) Inventor: Abe M. Sher, Surfside, FL (US)

(21) Appl. No.: 15/626,272

(22) Filed: Jun. 19, 2017

Related U.S. Application Data
(60) Provisional application No. 62/351,981, filed on Jun. 19, 2016.

(51) Int. Cl. B01D 47/05; B01D 50/00; B01D 45/02

(52) U.S. Cl. CPC B01D 47/05; B01D 45/02; B01D 50/004

(57) ABSTRACT

Disclosed are methods, apparatuses, assemblies, devices and systems for removing pollutants from air within a space or an environment. Humidifiers introduce a pollutant trapping material into the air of the space or environment by evaporating the pollutant trapping material, wherein the pollutant trapping material adheres to pollutants in the air being purified. Dehumidifiers remove the pollutant trapping material, along with pollutants adhered thereto, from the air by dehumidifying it. The cooperation of the humidifier(s) and the dehumidifier(s) may be collaborated based on a combination of pollutant concentration level value(s) and relative humidity level value(s) measured in the air.

### RELATED APPLICATIONS

This application claims the priority of applicant's U.S. Provisional Patent Application No. 62/351,981, filed Jun. 19, 2016, The disclosure of the above mentioned 62/351,981, Provisional patent application, is hereby incorporated by reference in its entirety for all purposes.

### FIELD OF THE INVENTION

The present invention relates generally to the field of air conditioning and purification. More specifically the present invention relates to methods, apparatuses, assemblies, devices and systems for conditioning and purifying air.

### BACKGROUND

Air pollution is the introduction of particulates, biological molecules, or other harmful materials into Earth's atmosphere, causing diseases, death to humans, damage to other living organisms such as animals and food crops, or the natural or built environment. Air pollution may come from anthropogenic or natural sources. Indoor air pollution and urban air quality are listed as two of the world's worst toxic pollution problems in the 2008 Blacksmith Institute World's Worst Polluted Places report.

Air pollution is a significant risk factor for a number of health conditions including respiratory infections, heart disease, COPD, stroke and lung cancer. The health effects caused by air pollution may include difficulty in breathing, wheezing, coughing, asthma and worsening of existing respiratory and cardiac conditions. These effects can result in increased medication use, increased doctor or emergency room visits, more hospital admissions and premature death. The human health effects of poor air quality are far reaching, but principally affect the body's respiratory system and the cardiovascular system. individual reactions to air pollutants depend on the type of pollutant a person is exposed to, the degree of exposure, and the individual's health status and genetics. The most common sources of air pollution include particulates, ozone, nitrogen dioxide, and Sulphur dioxide.

Children aged less than five years that live in developing countries are the most vulnerable population in terms of total deaths attributable to indoor and outdoor air pollution. According to a 2014 WHO report, air pollution in 2012 caused the deaths of around 7 million people worldwide.

Scrubber systems (aka Chemical Scrubbers, Gas Scrubbers) are a diverse group of air pollution control devices that can be used to remove some particulates and/or gases from industrial exhaust streams. The first air scrubber was designed to remove carbon dioxide from the air of an early submarine, the Ictineo I, a role for which they continue to be used until today. Traditionally, the term “scrubber” has referred to pollution control devices that use liquid to wash unwanted pollutants from a gas stream. Recently, the term has also been used to describe systems that inject a dry reagent or slurry into a dirty exhaust stream to “wash out” acid gases. Scrubbers are one of the primary devices that control gaseous emissions, especially acid gases. Scrubbers can also be used for heat recovery from hot gases by flue-gas condensation. They are also used for the high flows in solar, PV, or LED processes.

There are several methods to remove toxic or corrosive compounds from exhaust gas and neutralize it.

Combustion is sometimes the cause of harmful xhausts, but, in many cases, combustion may also be used for exhaust gas cleaning if the temperature is high enough and enough oxygen is available.

The exhaust gases of combustion may contain substances considered harmful to the environment, and the scrubber may remove or neutralize those. A wet scrubber is used for cleaning air, fuel gas or other gases of various pollutants and dust particles. Wet scrubbing works via the contact of target compounds or particulate matter with the scrubbing solution. Solutions may simply be water (for dust) or solutions of reagents that specifically target certain compounds.

Process exhaust gas can also contain water-soluble toxic and/or corrosive gases like hydrochloric acid (HCl) or ammonia (NH3). These can be removed very well by a wet scrubber.

Removal efficiency of pollutants is improved by increasing residence time in the scrubber or by the increase of surface area of the scrubber solution by the use of a spray nozzle, packed towers or an aspirator. Wet scrubbers may increase the proportion of water in the gas, resulting in a visible stack plume, if the gas is sent to a stack.

Wet scrubbers can also be used for heat recovery from hot gases by flue-gas condensation. In this mode, termed a condensing scrubber, water from the scrubber drain is circulated through a cooler to the nozzles at the top of the scrubber. The hot gas enters the scrubber at the bottom. If the gas temperature is above the water dew point, it is initially cooled by evaporation of water drops. Further cooling cause water vapors to condense, adding to the amount of circulating water.

The condensation of water releases significant amounts of low temperature heat (more than 2 gigajoules (560 kWh) per ton of water) that can be recovered by the cooler for various purposes (e.g. district heating purposes).

Excess condensed water must continuously be removed from the circulating water.

The gas leaves the scrubber at its dew point, so even though significant amounts of water may have been removed from the cooled gas, it is likely to leave a visible stack plume of water vapor.

A dry or semi-dry scrubbing system, unlike the wet scrubber, does not saturate the flue gas stream that is being treated with moisture. In some cases no moisture is added, while in others only the amount of moisture that can be evaporated in the flue gas without condensing is added. Therefore, dry scrubbers generally do not have a stack steam plume or wastewater handling/disposal requirements. Thy scrubbing systems are used to remove acid gases (such as SO₂ and HCl) primarily from combustion sources.

There are a number of dry type scrubbing system designs. However, all consist of two main sections or devices: a device to introduce the acid gas sorbent material into the gas stream and a particulate matter control device to remove reaction products, excess sorbent material as well as any particulate matter already in the flue gas.

Dry scrubbing systems can be categorized as dry sorbent injectors (DSIs) or as spray dryer absorbers (SDAs). Spray dryer absorbers are also called semi-dry scrubbers or spray dryers.

Dry scrubbing systems are often used for the removal of odorous and corrosive gases from wastewater treatment plant operations. The medium used is typically an activated alumina compound impregnated with materials to handle specific gases such as hydrogen sulfide. Media used can be mixed together to offer a wide range of removal for other odorous compounds such as methyl mercaptans, aldehydes, volatile organic compounds, dimethyl sulfide and dimethyl disulfide.

Dry sorbent injection involves the addition of an alkaline material (usually hydrated lime, soda ash, or sodium bicarbonate) into the gas stream to react with the acid gases. The sorbent can be injected directly into several different locations: the combustion process, the flue gas duct (ahead of the particulate control device), or an open reaction chamber (if one exists). The acid gases react with the alkaline sorhents to form solid salts which are removed in the particulate control device. These simple systems can achieve only limited acid gas (SO2 and HCl) removal efficiencies. Higher collection efficiencies can be achieved by increasing the flue gas humidity (i.e., cooling using water spray). These devices have been used on medical waste incinerators and a few municipal waste combustors.

In spray dryer absorbers, the flue gases are introduced into an absorbing tower (dryer) where the gases are contacted with a finely atomized alkaline slurry. Acid gases are absorbed by the slurry mixture and react to form solid salts which are removed by the particulate control device. The heat of the flue gas is used to evaporate all the water droplets, leaving a non-saturated flue gas to exit the absorber tower. Spray dryers are capable of achieving high (80+%) acid gas removal efficiencies. These devices have been used on industrial and utility boilers and municipal waste incinerators.

Many chemicals can be removed from exhaust gas also by using absorber material. The flue gas is passed through a cartridge which is filled with one or several absorbed materials and has been adapted to the chemical properties of the components to be removed. This type of scrubber is sometimes also called dry scrubber. The absorber material has to be replaced after its surface is saturated.

Heating, ventilation and air conditioning (HVAC) is the technology of indoor and vehicular environmental comfort. Its goal is to provide thermal comfort and acceptable indoor air quality. HVAC system design is a sub discipline of mechanical engineering, based on the principles of thermodynamics, fluid mechanics, and heat transfer. Refrigeration is sometimes added to the field's abbreviation as HVAC&R or HVACR, or ventilating is dropped as in HACR (such as the designation of HACR-rated circuit breakers).

HVAC is an important part of residential structures such as single family homes, apartment buildings, hotels and senior living facilities, medium to large industrial and office buildings such as skyscrapers and hospitals, onboard vessels, and in marine environments, where safe and healthy building conditions are regulated with respect to temperature and humidity, using fresh air from outdoors.

Ventilating or ventilation (the V in HVAC) is the process of exchanging or replacing air in any space to provide high indoor air quality which involves temperature control, oxygen replenishment, and removal of moisture, odors, smoke, heat, dust, airborne bacteria, carbon dioxide, and other gases. Ventilation removes unpleasant smells and excessive moisture, introduces outside air, keeps interior building air circulating, and prevents stagnation of the interior air.

Ventilation includes both the exchange of air to the outside as well as circulation of air within the building. It is one of the most important factors for maintaining acceptable indoor air quality in buildings. Methods for ventilating a building may be divided into mechanical/forced and natural types.

The three central functions of heating, ventilation, and air conditioning are interrelated, especially with the need to provide thermal comfort and acceptable indoor air quality within reasonable installation, operation, and maintenance costs. HVAC systems can be used in both domestic and commercial environments. HVAC systems can provide ventilation, reduce air infiltration, and maintain pressure relationships between spaces. The means of air delivery and removal from spaces is known as room air distribution.

In modem buildings the design, installation, and control systems of these functions are integrated into one or more HVAC systems. For very small buildings, contractors normally estimate the capacity and type of system needed and then design the system, selecting the appropriate refrigerant and various components needed. For larger buildings, building service designers, mechanical engineers, or building services engineers analyze, design, and specify the HVAC systems. Specialty mechanical contractors then fabricate and commission the systems. Building permits and code-compliance inspections of the installations are normally required for all sizes of building.

Although HVAC is executed in individual buildings or other enclosed spaces (like NORAD's underground headquarters), the equipment involved is in some cases an extension of a larger district heating (DH) or district cooling (DC) network, or a combined DHC network. In such cases, the operating and maintenance aspects are simplified and metering becomes necessary to bill for the energy that is consumed, and in some cases energy that is returned to the larger system. For example, at a given time one building may be utilizing chilled water for air conditioning and the warm water it returns may be used in another building for heating, or for the overall heating-portion of the DHC network (likely with energy added to boost the temperature).

Basing HVAC on a larger network helps provide an economy of scale that is often not possible for individual buildings, for utilizing renewable energy sources such as solar heat, winter's cold, the cooling potential in some places of lakes or seawater for free cooling, and the enabling function of seasonal thermal energy storage.

Heaters are appliances whose purpose is to generate heat (i.e. warmth) for the building. This can he done via central heating. Such a system contains a boiler, furnace, or heat pump to heat water, steam, or air in a central location such as a furnace room in a home, or a mechanical room in a large building. The heat can be transferred by convection, conduction, or radiation.

Ventilation is the process of changing or replacing air in any space to control temperature or remove any combination of moisture, odors, smoke, heat, dust, airborne bacteria, or carbon dioxide, and to replenish oxygen. Ventilation includes both the exchange of air with the outside as well as circulation of air within the building. It is one of the most important factors for maintaining acceptable indoor air quality in buildings. Methods for ventilating a building may be divided into mechanical/forced and natural types.

Mechanical, or forced, ventilation is provided by an air handler (AHU) and used to control indoor air quality. Excess humidity, odors, and contaminants can often be controlled via dilution or replacement with outside air. However, in humid climates more energy is required to remove excess moisture from ventilation air.

An air conditioning system, or a standalone air conditioner, provides cooling and humidity control for all or part of a building. Air conditioned buildings often have sealed windows, because open windows would work against the system intended to maintain constant indoor air conditions. Outside, fresh air is generally drawn into the system by a vent into the indoor heat exchanger section, creating positive air pressure. The percentage of return air made up of fresh air can usually be manipulated by adjusting the opening of this vent. Typical fresh air intake is about 10%.

Air conditioning and refrigeration are provided through the removal of heat. Heat can be removed through radiation, convection, or conduction. Refrigeration conduction media such as water, air, ice, and chemicals are referred to as refrigerants. A refrigerant is employed either in a heat pump system in which a compressor is used to drive thermodynamic refrigeration cycle, or in a free cooling system which uses pumps to circulate a cool refrigerant (typically water or a glycol mix).

Air cleaning and filtration removes particles, contaminants, vapors and gases from the air. The filtered and cleaned air then is used in heating, ventilation and air conditioning. Air cleaning and filtration should be taken in account when protecting our building environments.

A humidifier is a device that increases humidity (moisture) in a single room or an entire building. In the home, point-of-use humidifiers are commonly used to humidify a single room, while whole-house or furnace humidifiers, which connect to a home's HVAC system, provide humidity to the entire house. Medical ventilators often include humidifiers for increased patient comfort. Large humidifiers are used in commercial, institutional, or industrial contexts, often as part of a larger HVAC system.

Low humidity may occur in hot, dry desert climates, or indoors in artificially heated spaces. In winter, especially when cold outside air is heated indoors, the humidity may drop as low as 10-20%. This low humidity can cause adverse health effects, by drying out mucous membranes such as the lining of the nose and throat, and can cause respiratory distress. The low humidity also can affect wooden furniture, causing shrinkage and loose joints or cracking of pieces. Books, papers, and artworks may shrink or warp and become brittle in very low humidity.

In addition, static electricity may become a problem conditions of low humidity, destroying semiconductor devices and causing static cling of textiles, and causing dust and small particles to stick stubbornly to electrically charged surfaces.

Overuse of a humidifier can raise the relative humidity to excessive levels, promoting the growth of dust mites and mold, and can also cause hypersensitivity pneumonitis (humidifier lung). A relative humidity of 30% to 50% is recommended for most homes. A properly installed and located hygrostat should be used to monitor and control humidity levels automatically, or a well-informed and conscientious human operator must constantly check for correct humidity levels.

Industrial humidifiers are used when a specific humidity level must be maintained to prevent static electricity buildup, preserve material properties, and ensure a comfortable and healthy environment for workers or residents.

Static problems are prevalent in industries such as packaging, printing, paper, plastics, textiles, electronics, automotive manufacturing and pharmaceuticals. Friction can produce static buildup and sparks when humidity is below 45% relative humidity (RH). Between 45% and 55% RH, static builds up at reduced levels, while humidity above 55% RH ensures that static will never buildup. The American Society of Heating, Refrigerating and Air Conditioning Engineers (ASHRAE) has traditionally recommended a range of 45-55% RH in data centers to prevent sparks that can damage IT equipment. Humidifiers are also used by manufacturers of semiconductors and in hospital operating rooms.

Printers and paper manufacturers use humidifiers to prevent shrinkage and paper curl. Humidifiers are needed in cold storage rooms to preserve the freshness of food against the dryness caused by cold temperatures. Art museums use humidifiers to protect sensitive works of art, especially in exhibition galleries, where they combat the dryness caused by heating for the comfort of visitors during winter.

A “portable” humidifier may range in size from a small tabletop appliance to a large floor-mounted unit. The water is usually supplied by manually filling the unit on a periodic basis. The most common portable humidifier, an “evaporative”, “cool moisture”, or “wick humidifier”, consists of just a few basic parts: a reservoir, wick and fan. One type of evaporative humidifier makes use of just a reservoir and wick. Sometimes called a “natural humidifier”, these are usually non-commercial devices that can be assembled at little or no cost.

A vaporizer (steam humidifier, warm mist humidifier) heats or boils water, releasing steam and moisture into the air. A medicated inhalant can also be added to the steam vapor to help reduce coughs. Vaporizers may be more healthful than cool mist types of humidifiers because steam is less likely to convey mineral impurities or microorganisms from the standing water in the reservoir,

An impeller humidifier (cool mist humidifier) uses a rotating disc to fling water at a diffuser, which breaks the water into fine droplets that float into the air.

An ultrasonic humidifier uses a ceramic diaphragm vibrating at an ultrasonic frequency to create water droplets that silently exit the humidifier in the form of cool fog. Usually the mist gets forced out by a tiny fan, while some ultra mini models have no fans. The models without fans are meant mainly for personal use. Ultrasonic humidifiers use a piezoelectric transducer to create a high frequency mechanical oscillation in a film of water. This forms an extremely fine mist of droplets about one micron in diameter that is quickly evaporated into the air flow.

For buildings with a forced-air furnace, a humidifier may be installed into the furnace. They can also protect wooden objects, antiques and other furnishings which may be sensitive to damage from overly dry air. In colder months, they may provide modest energy savings, since as humidity increases, occupants may feel warm at a lower temperature.

A dehumidifier is a household appliance, or an industrial device, which reduces the level of humidity in the air, usually for health or comfort reasons, or to eliminate musty odor. Large dehumidifiers are also used in commercial buildings such as indoor ice rinks to control the humidity level.

By their operation, dehumidifiers extract water from the conditioned air. This collected water (usually called condensate) is not normally used for drinking, and is often discarded. Some designs, such as the ionic membrane dehumidifier, dispose of excess water in a vapor rather than liquid form. The energy efficiency of dehumidifiers can vary widely.

Thermal condensation dehumidification methods rely on drawing air across a cold surface. Since the saturation vapor pressure of water decreases with decreasing temperature, the water in the air condenses on the surface, separating the water from the air.

Mechanical/refrigeration dehumidifiers, the most common type, usually work by drawing moist air over a refrigerated coil with a fan. The cold evaporator coil of the refrigeration device condenses the water, which is removed, and then the air is reheated by the condenser coil. The now dehumidified, re-warmed air is released into the room. This process works most effectively at higher ambient temperatures with a high dew point temperature. In cold climates, the process is less effective. It is most effective at over 45% relative humidity; higher if the air is cold.

A conventional air conditioner is very similar to a mechanical/refrigeration dehumidifier and inherently acts as a dehumidifier when chilling the air. In an air conditioner, however, the air passes over the cold evaporator coils and then directly into the room. It is not re-heated by passing over the condenser, as in a refrigeration dehumidifier. Instead, the refrigerant is pumped by the compressor to a condenser which is located outside the room to be conditioned, and the heat is then released to the outside air. Conventional air conditioners use additional energy exhausting air outside, and new air can have more moisture than the room needs, such as a pool room that already holds a high amount of moisture in the air.

The water that condenses on the evaporator in an air conditioner is usually routed to remove extracted water from the conditioned space. Newer high-efficiency window units use the condensed water to help cool the condenser coil by evaporating the water into the outdoor air, while older units simply allowed the water to drip outside.

Spray Dehumidifiers—When water is chilled below the atmospheric dew point, atmospheric water will condense onto it faster than water evaporates from it. Spray dehumidifiers mix sprays of chilled water and air to capture atmospheric moisture. They also capture pollutants and contaminants like pollen, for which purpose they are sometimes called “air washers”.

Makeshift dehumidifiers—Because window air conditioner units have condensers and expansion units, some of them can be used as makeshift dehumidifiers by sending their heat exhaust back into the same room as the cooled air, instead of the outside environment. If the condensate from the cooling coils is drained away from the room as it drips off the cooling coils, the result will be room air that is drier but slightly warmer.

Absorption/desiccant dehumidification—This process uses a special humidity-absorbing material called a desiccant, which is exposed to the air to be conditioned. The humidity-saturated material is then moved to a different location, where it is “recharged” to drive off the humidity, typically by heating it. The desiccant can be mounted on a belt or other means of transporting it during a cycle of operation.

Dehumidifiers which work according to the absorption principle are especially suited for high humidity levels at low temperatures. They are often used in various sectors in industry because humidity levels below 35% can be achieved.

Because of the lack of compressor parts desiccant dehumidifiers are often lighter and quieter than compressor dehumidifiers. Desiccant dehumidifiers can also operate at lower temperatures than compressor dehumidifiers as the unit lacks coils which are unable to extract moisture from the air at lower temperatures.

Most portable dehumidifiers are equipped with a condensate collection receptacle, typically with a float sensor that detects when the collection vessel is full, to shut off the dehumidifier and prevent an overflow of collected water. In humid environments, these buckets will generally fill with water in 8-12 hours, and may need to be manually emptied and replaced several times per day to ensure continued operation.

Many portable dehumidifiers can also be adapted to connect the condensate drip output directly to a drain via a hose. Some dehumidifier models can tie into plumbing drains or use a built-in water pump to empty themselves as they collect moisture. Alternatively, a separate condensate pump may be used to move collected water to a disposal location when gravity drainage is not possible.

There is a need, the field of air conditioning and purification, for improved methods, apparatuses, assemblies, devices and systems, utilizing HVAC and humidity control related techniques, for: scrubbing, removing pollutants from, regulating the relative humidity in and/or enhancing the efficiency of HVAC systems treating—the air within a space or an environment.

### SUMMARY OF THE INVENTION

The present invention includes method, apparatuses, assemblies, devices and systems for conditioning and purifying air. According to some embodiments there may be provided a method of removing pollutants from air, also referred to as purifying air, including the steps of introducing pollutant trapping material into the air at a first location and then removing the pollutant trapping material, along with trapped pollutants, from the air at a second location. The pollutant trapping material may be in the form of particles in the air or may he evaporated within and defused throughout the air being purified. According to some embodiments, the pollutant trapping material may adhere to pollutants in air being purified. According to further embodiments, the pollutant trapping material may dissolve pollutants in air being purified.

According to some embodiments, the pollutant trapping material may be composed partly or entirely of water (H2O). According to some embodiments, the pollutant trapping material may include antifungal, anti-bacterial and/or anti-viral agents. According to embodiments of the present invention, the pollutant trapping material may be introduced into air to be purified by one or more humidifiers at a first set of one or more locations. The pollutant trapping material may be removed from the air to be purified, after traveling through some volume of the air to be purified, by one or more de-humidifiers located at a second set of one or more locations. According to some embodiments, pollutant trapping material may move from the point of introduction towards the dehumidifier(s) due to diffusion and/or gravity. According to further embodiments, there may be provided one or more air movers, such as fans, to move air from the first set of one or more locations, where the water based pollutant trapping material is introduced into the air, towards the second set of one or more locations where the water based pollutant trapping material is removed from the air.

According to some embodiments of the present invention, there may be provided an air purification system including one or more air humidifiers located at a first set of one or more locations within a space, one or more air dehumidifiers located at a second set of one or more locations within the space, one or more air movers adapted to move air from the first set of one or more locations within the space to the second set of one or more locations with the space, and a system controller adapted to regulate in a coordinated manner operation of the one or more humidifiers, one or more dehumidifiers and air movers. The system controller may regulate the various system devices responsive to signals received from sensors, such as (1) temperature sensors, (2) airflow sensors, (3) pollutant particle sensors, and/or (4) humidity sensors, positioned at various locations throughout the space. The system controller may regulate operation of system components in order to reach and/or maintain parameters such as: (1) pollutant trapping material density in the air (e.g. humidity), (2) pollutant trapping material flow from the first set of one or more locations to the second set of one or more locations, (3) air pollutant (particle) density, and/or (4) air temperature.

According to some embodiments, responsive to detection of a pollutant density in the air reaching or exceeding a specific level, the system controller may cause one or more humidifiers to boost introduction of pollutant trapping material into the air. The controller may also cause one or more dehumidifiers to boost pollutant trapping material from the air. Air mover operation may also be boosted. If humidity levels increase above a certain level, dehumidifier and airflow operation may be boosted relatively more than humidifier operation. According to some system embodiments of the present invention, the system dehumidifiers may be operated at a level sufficient to remove humidity introduced into the air by system humidifiers and by occupants, and other humidity sources, within the space being service by the system.

The types of space within which a system according to embodiments of the present invention may be used include: (1) residential, (2) office, (3) industrial, (4) public; entertainment venue, (5) parks, (6) cities and open spaces.

According to specific embodiments, there may be provided an air purification system for cleaning air in a space, which system operates by humidifying air to be cleaned using a combination of one or more humidifiers and removing the moisture using one or more dehumidifiers, thereby creating a continuous “air wash” in the space.

As an ancillary product of the system's operation, the one or more dehumidifiers collecting moisture/water from the air may generate drinking water. The contamination collected by the air washer and by the dehumidifier can be removed by a simple filtering and/or maintenance procedure that may only require few minutes per week. According to some embodiments, the one or more dehumidifiers may only use desiccant and/or liquid desiccant for dehumidification.

Additionally, the system may control scent in the space, and may remove particles from the air which are larger than 5 microns at a rate of over 95% at each path. Within some indoor spaces, the system may, with air circulation features, remove particles at a rate higher than 99%. By controlling humidity, the system may also reduce the energy used in the building as an air-conditioning system for the same space will need to consume much less energy if it does not need to deal with condensing humidity.

Embodiments of the present invention may include features such as:
1. A system which comprises: (1) a humidifier which is being placed in the room and fed by a water supply source (e.g. a tap); and (2) a liquid desiccant dehumidifier that produces water from air; and/or a control connection (wired or wireless) connecting between them and/or control their collaborative cooperation.
2. The humidifier may humidify the air to a comfort level humidification (for example at 25 degrees centigrade to a 50% relative humidity [RH]) and a dehumidifier may reduce the humidity (for example to a 45% RH).
3. The units will be located in different locations in the room or space.
4. The system above where both units, humidifier and de-humidifier, are built into one monoblock device.
5. The system with a mechanism to add scent additives to the air washer via the water.

### BRIEF DESCRIPTION OF THE DRAWINGS

The subject matter regarded as the invention is particularly pointed out and distinctly claimed in the concluding portion of the specification, The invention, however, both as to organization and method of operation, together with objects, features, and advantages thereof, may best be understood by reference to the following detailed description when read with the accompanying drawings and appendix:

FIG. 1A, is a high level block diagram showing the main components of an exemplary system for conditioning and purifying air, in accordance with some embodiments of the present invention;

FIG. 1B, is a block diagram showing, in further detail, the main components of an exemplary system for conditioning and purifying air, in accordance with some embodiments of the present invention;

FIG. 2A, is a flowchart showing the main steps executed as part of an exemplary process for conditioning and purifying air, in accordance with some embodiments of the present invention;

FIG. 2B, is a flowchart showing the main steps executed as part of a first exemplary operation scenario process for conditioning and purifying air, in accordance with some embodiments of the present invention;

FIG. 2C, is a flowchart showing the main steps executed as part of a second exemplary operation scenario process for conditioning and purifying air, in accordance with some embodiments of the present invention;

FIG. 2D, is a flowchart showing the main steps executed as part, of a third exemplary operation scenario process for conditioning and purifying air, in accordance with some embodiments of the present invention;

FIG. 3A, is a block diagram showing a schematic view of a first configuration of: Humidifiers, Dehumidifiers, Sensors and Air Movers, in accordance with some embodiments of the present invention;

FIG. 3B, is a block diagram showing a schematic view of a second configuration of: Humidifiers, Dehumidifiers, Sensors and Air Movers, in accordance with some embodiments of the present invention;

FIG. 4A, is a block diagram showing the main components and layout of an exemplary—diffusion based purification enhancing configuration of a system for conditioning and purifying air, in accordance with some embodiments of the present invention;

; and

FIG. 4B, is a block diagram showing the main components and layout of an exemplary—gravitational based purification enhancing configuration—of a system for conditioning and purifying air, in accordance with sonic embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, reisters or other such inthrmation storage, transmission or display devices.

In addition, throughout the specification discussions utilizing terms such as “storing”, “hosting”, “caching”, “saving”, or the like, may refer to the action and/or processes of ‘writing’ and ‘keeping’ digital inthrmation on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

Throughout the specification, the terms ‘Purification’, ‘Conditioning’ and/or ‘Purification and Conditioning’, and/or any other more specific terms such as: ‘air conditioning’, ‘air purification’, ‘air cleaning’, ‘air filtering’, or the like, is not to limit the scope of the associated teachings or features, all of which may apply to any form of air treatment and environment conditions control.

The present invention includes method, apparatuses, assemblies, devices and systems for conditioning and purifying air. According to some embodiments there may be provided a method of removing pollutants from air, also referred to as purifying air, including the steps of introducing pollutant trapping material into the air at a first location and then removing the pollutant trapping material, along with trapped pollutants, from the air at a second location. The pollutant trapping material may be in the form of particles in the air or may be evaporated within and defused throughout the air being purified. According to some embodiments, the pollutant trapping material may adhere to pollutants in air being purified. According to further embodiments, the pollutant trapping material may dissolve pollutants in air being purified.

According to some embodiments, the pollutant trapping material may be composed partly or entirely of water (H₂O). According to sonic embodiments, the pollutant trapping material may include antifungal, anti-bacterial and/or anti-viral agents. According to embodiments of the present invention, the pollutant trapping material may be introduced into air to be purified by one or more humidifiers at a first set of one or more locations. The pollutant trapping material may be removed from the air to be purified, after traveling through some volume of the air to be purified, by one or more de-humidifiers located at a second set of one or more locations. According to some embodiments, pollutant trapping material may move from the point of introduction towards the dehumidifier(s) due to diffusion and/or gravity. According to further embodiments, there may be provided one or more air movers, such as fans, to move air from the first set of one or more locations, where the water based. pollutant trapping material is introduced into the air, towards the second set of one or more locations where the water based pollutant trapping material is removed from the air.

According to some embodiments of the present invention, there may be provided an air purification system including one or more air humidifiers located at a first set of one or more locations within a space, one or more air dehumidifiers located at a second set of one or more locations within the space, one or more air movers adapted to move air from the first set of one or more locations within the space to the second set of one or more locations with the space, and a system controller adapted to regulate in a coordinated manner operation of the one or more humidifiers, one or more dehumidifiers and air movers. The system controller may regulate the various system devices responsive to signals received from sensors, such as (1) temperature sensors, (2) airflow sensors, (3) pollutant particle sensors, and/or (4) humidity sensors, positioned at various locations throughout the space. The system. controller may regulate operation of system components in order to reach and/or maintain parameters such as: (1) pollutant trapping material density/concentration in the air (e.g. humidity), (2) pollutant trapping material flow from the first set of one or more locations to the second set of one or more locations, (3) air pollutant (particle) density/concentration, and/or (4) air temperature.

According to some embodiments, responsive to detection of a pollutant density/concentration. in the air reaching or exceeding a specific level, the system controller may cause one or more humidifiers to boost introduction of pollutant trapping material into the air. The controller may also cause one or more dehumidifiers to boost pollutant trapping material from the air. Air mover operation may also be boosted. If humidity levels increase above a certain level, dehumidifier and airflow operation may be boosted relatively more than humidifier operation. According to some system embodiments of the present invention, the system dehumidifiers may be operated at a level sufficient to remove humidity introduced into the air by system humidifiers and by occupants, and other humidity sources, within the space being service by the system.

According to some embodiments, high partial vapor/humidity pressure of/in the Humidifier extracts water to/into the air. The System/Scrubber may thus “mechanically’ wash the air and particles/pollutants therein are collected. The dehumidifier may contain liquid desiccant, at a substantially low (e.g. very low) partial vapor/humidity pressure facilitating the collection of the water in the air and small particles/pollutants attracted/adhered to it.

If/once the air in the space/enviromnent is/becomes dry to a certain extent (i.e. not humid enough)—for example in a close room after some time of system operation—the liquid desiccant may slow/stop working since there is not enough water/humidity in the air. The operation of the Humidifier may, in response, be boosted/initiated by the System Controller to intermittently/constantly bring more water into the air, increase the relative humidity in it and thus enhance/accelerate/retain the speed/work of the liquid desiccant of the Dehumidifier, collectively (the Humidifier and the Dehumidifier) enabling continuous air washing/purifying/cleaning of the space/environment by the system.

The types of space/volume within which a system according to embodiments of the present invention may be used in/for, may for example include: (1) residential, (2) office, (3) industrial, (4) public/entertainment venue, (5) parks, (6) cities and open spaces.

According to specific embodiments, there may be provided an air purification system for cleaning air in a space, which system operates by humidifying air to be cleaned using a combination of one or more humidifiers and removing the moisture using one or more dehumidifiers, thereby creating a continuous “air wash ” in the space.

As an ancillary product of the system's operation, the one or more dehumidifiers collecting moisture/water from the air may generate drinking water. The contamination collected by the air washer and by the dehumidifier can be removed by a simple filtering and/or maintenance procedure that may only require a few minutes per week. According to some embodiments, the one or more dehumidifiers may only use desiccant and/or liquid desiccant for dehumidification.

According to embodiments, desiccant, solid or liquid, may be used to attract water vapor from air because of the difference in vapor pressure between the air and the surface of the desiccant solution. Dehumidification process is said to occur when the vapor pressure of the surface of the desiccant is less than that of air and continues until the desiccant reaches equilibrium with air. Desiccants can be regenerated at low temperature, from approximately 50° C. to 80° C. Thus, the regeneration process could be driven by heat sources with a relatively low temperature of approximately 70° C., such as electrical heaters, solar energy, waste heat, and geothermal power.

Desiccants can be classified into solid and liquid desiccant. Several types of solid materials can hold water vapor; they are silicas, polymers, zeolites, aluminas, hydra:table salts, and mixtures. Liquid desiccant types include: sodium chloride, calcium chloride, lithium chloride, lithium bromide, Tri-ethylene glycol, and a mixture of 50% calcium chloride and 50% lithium chloride. Liquid desiccants exhibit properties including low vapor pressure, low crystallization point, high density, low viscosity, and low regeneration temperature.

Additionally, the system may control scent in the space; and may remove particles from the air which are larger than a specific size, for example larger than 5 microns; at a substantially high rate, for example at a rate of over 95% at each path. Within some indoor spaces, the system may, with air circulation features, remove particles at a rate higher than 99%. By controlling humidity, the system may also reduce the energy used in the building as an air-conditioning system for the same space will need to consume much less energy if it does not need to deal with condensing humidity.

Embodiments of the present invention may include features such as:
1. A system which comprises: (1) a humidifier which is being placed in the space (e.g. room) and fed by a supply from a water source (e.g. a tap); and (2) a liquid desiccant dehumidifier that produces water from air; and/or a control connection (wired or wireless) connecting between them and/or control their collaborative cooperation.
2. The humidifier may humidify the air to a comfort level humidification (for example at 25 degrees centigrade to a 50% relative humidity [RH]) and a dehumidifier may reduce the humidity (for example to a 45% RH).
3. The units will be located in different locations in the room or space.
4. The system above where both units, humidifier and de-humidifier, are built into one monoblock device.
5. The system with a mechanism to add scent additives to the air washer via the water

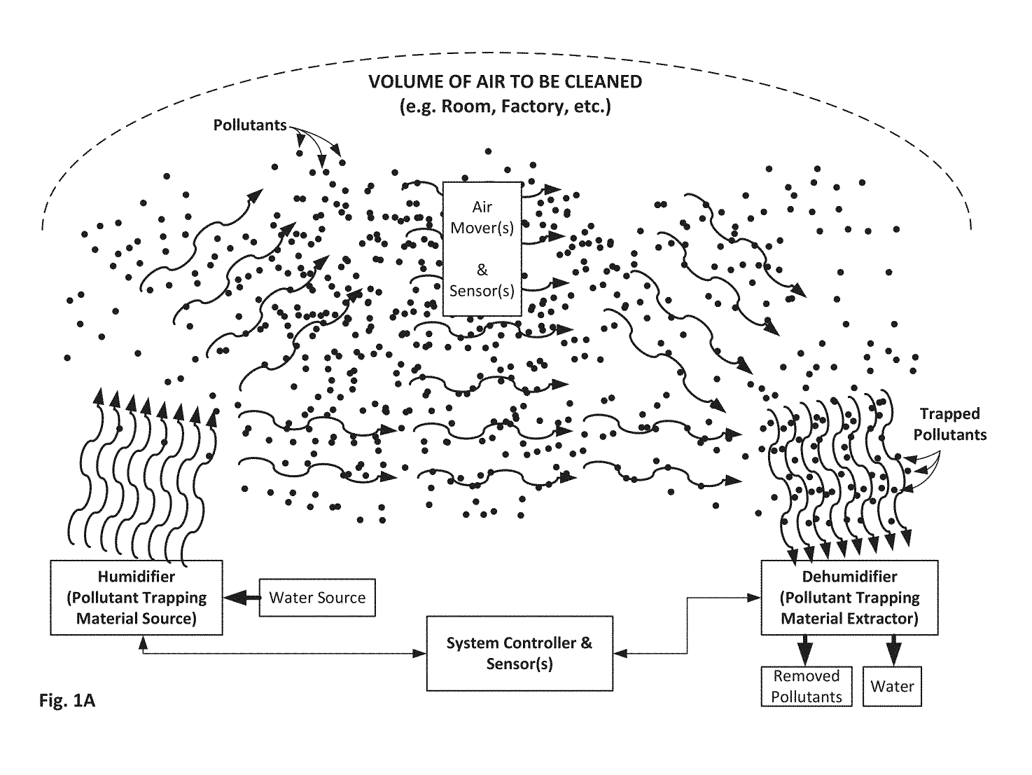

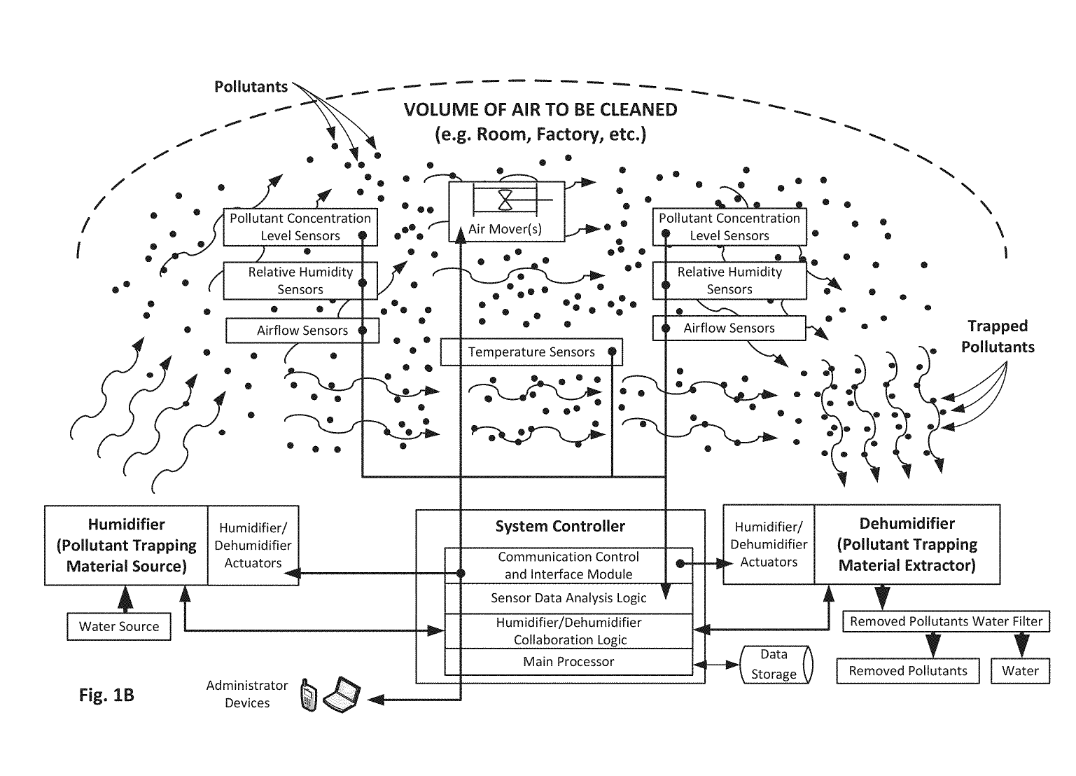

In FIG. 1A, there is shown a high level block diagram showing the main components of an exemplary system for conditioning and purifying air, in accordance with some embodiments of the present invention. The shown system includes a humidifier, connected to a water source, for humidifying the water and pollutant trapping material within it, introducing it into the space, environment or volume, which air is being purified.

The shown air mover(s) (e.g. fan, blower, air pump) enhances the movement of the pollutant trapping material from the proximity of the humidifier and towards the shown dehumidifier. The dehumidifier absorbs/Liquefies the water vapors along with the pollutant trapping material and pollutant particles adhered thereto. The byproduct of the dehumidifier is optionally separated/filtered into the removed pollutants and water. The water may be fed back into the water feeding the humidifier.

The system controller manages the operation of the humidifier, dehumidifier and air mover(s), at least partially based on readouts from the shown sensor(s). The controller may boost, lower and/or completely halt the operation of the humidifier, the dehumidifier and/or the air mover(s), based on sensor(s) provided data values, in accordance and/or combination with one or more operation scenario instruction sets that provide sensor(s) value, or value combination, based instructions, optionally in combination with other considered factors and inputs (e.g. time of day, number of persons present in the space/environment).

In FIG. 1B, there is shown a block diagram showing, in further detail, the main components of an exemplary system for conditioning and purifying air, in accordance with some embodiments of the present invention.

The shown system controller includes: a humidifier/dehumidifier collaboration logic for operating the humidifier and dehumidifier in concert to collectively maintain an aspired pollution level (e.g. maximal pollutant concentration levels in air) and/or aspired relative humidity levels, in the space.

The humidifier/dehumidifier collaboration logic manages the operation of at least the humidifier, the dehumidifier and the air mover(s) based on parameters/instructions received from the sensor data analysis logic as a result of the analysis of readouts from sensors in the space/environment. Sensors shown, include: pollutant concentration level sensors, relative humidity sensors, air flow sensors and temperature sensors (e.g. thermometers).

The communication and interface module, may utilize a wired or wireless connection for relaying instructions to and receiving operation parameters from system components, including: the humidifiers, dehumidifiers, sensors, air movers and/or actuators. The communication and interface module may also facilitate remote control and interface with the system, through a networked administrator device running a client/mobile computer application and/or a web application. The shown data storage is used to store system and system components operation data, for example, operation logs and parameters, sensor readouts and/or operation schemes and rules.

The ‘removed-pollutants water filter’ shown, is utilized for removing pollutants and/or residual pollutant removing materials from the dehumidification products, and collecting the remaining liquefied water humid/vapor. The humidifier/dehumidifier actuators, moves, mobilizes, shifts, and/or directs—the humidifier and/or dehumidifier—to enhance the movement of the air in the space/environment from the humidifier, or proximity thereof, and towards the dehumidifier and to thus expedite the process of air purification in the space and/or the humidification/dehumidification (increase/decrease of relative humidity) of the air within it.

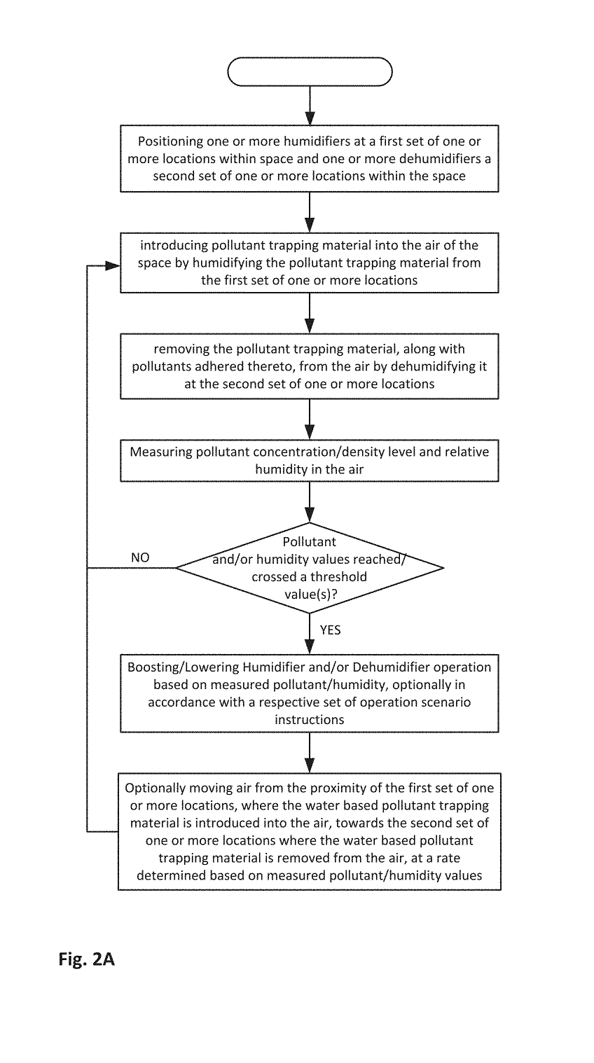

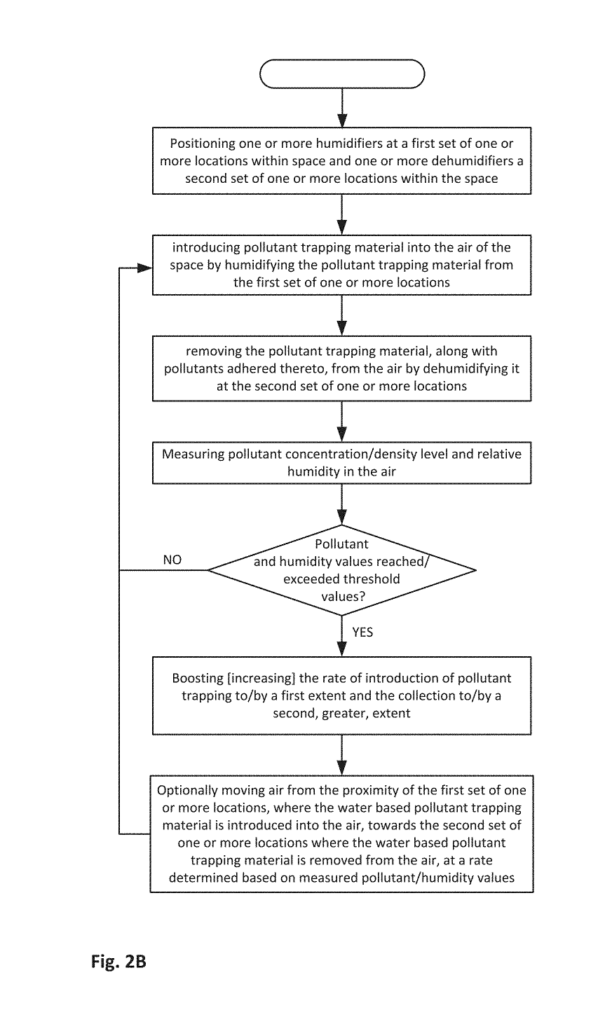

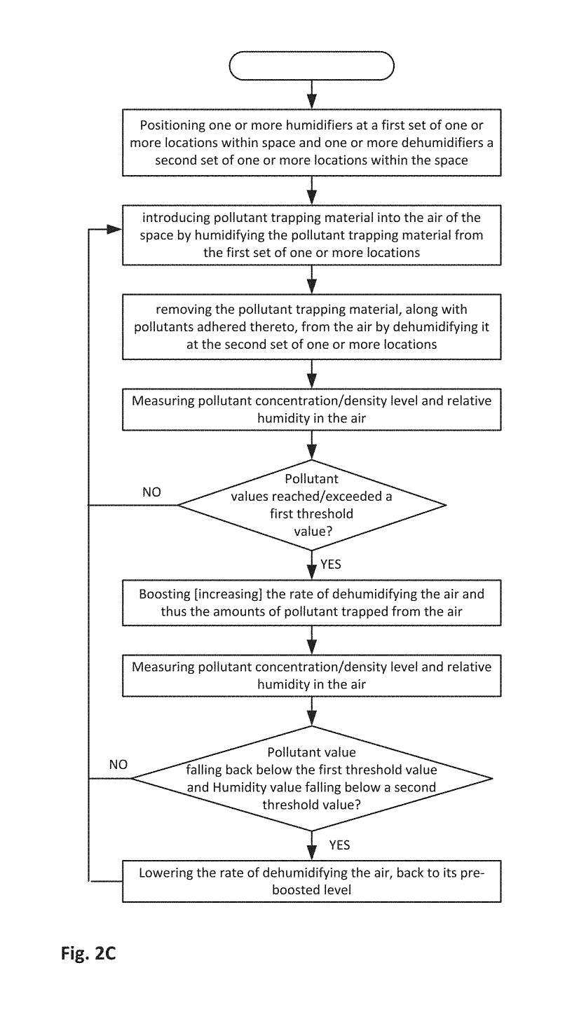

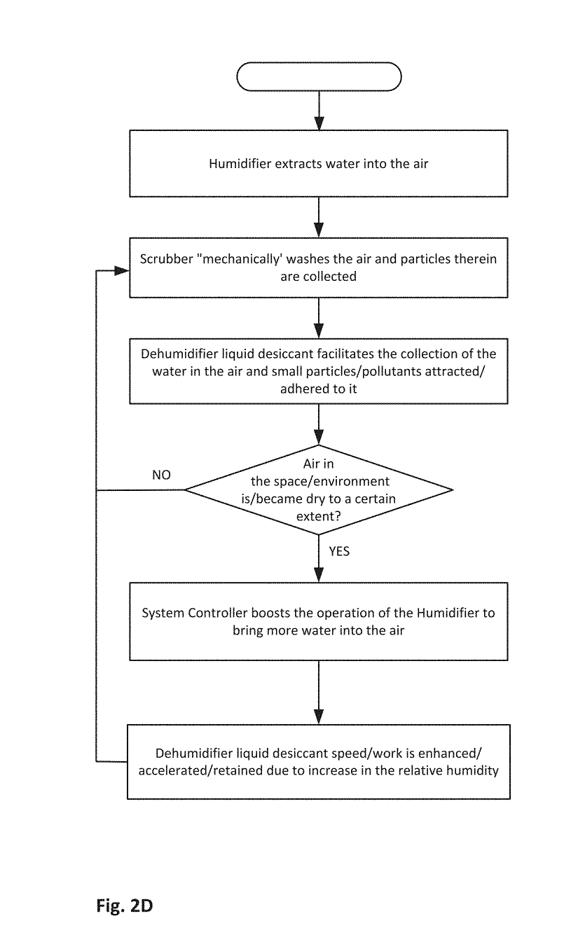

FIG. 2A, is a flowchart showing the main steps executed as part of an exemplary process for conditioning and purifying air, in accordance with some embodiments of the present invention.

The shown process, includes the following steps: (1) Positioning one or more humidifiers at a first set of one or more locations within a space and one or more dehumidifiers at a second set of one or more locations within the space; (2) introducing pollutant trapping material causing its diffusion away from the first set of one or more locations; (3) removing the pollutant trapping material, along with pollutants adhered thereto, from the air by dehumidifying it at the second set of one or more locations; (4) Measuring the pollutant concentration level and relative humidity in the space; (5) If the pollutant and/or humidity values reached/crossed a threshold value(s), boosting/lowering humidifier and/or dehumidifier operation based on the measured pollutant/humidity; and or (6) Moving air from the proximity of the first set of one or more locations, where the water based pollutant trapping material is introduced into the air, towards the second set of one or more locations where the water based pollutant trapping material is removed from the air, at a rate determined based on measured pollutant/humidity.

FIG. 2B, is a flowchart showing the main steps executed as part of a first exemplary operation scenario process for conditioning and purifying air, in accordance with some embodiments of the present invention.

The shown process, includes the following steps: (1) Positioning one or more humidifiers at a first set of one or more locations within a space and one or more dehumidifiers at a second set of one or more locations within the space; (2) introducing pollutant trapping material causing its diffusion away from the first set of one or more locations; (3) removing the pollutant trapping material, along with pollutants adhered thereto, from the air by dehumidifying it at the second set of one or more locations; (4) Measuring the pollutant concentration level and relative humidity in the space; (5) If both the pollutant and humidity values reached/exceeded their respective threshold values, boosting [increasing] the rate of introduction of pollutant trapping to/by a first extent and the collection to/by a second, greater, extent; and/or (6) Moving air from the proximity of the first set of one or more locations, where the water based pollutant trapping material is introduced into the air, towards the second set of one or more locations where the water based pollutant trapping material is removed from the air, at a rate determined based on measured pollutant/humidity.

FIG. 2C, is a flowchart showing the main steps executed as part of a second exemplary operation scenario process for conditioning and purifying air, in accordance with some embodiments of the present invention.

The shown process, includes the following steps: (1) Positioning one or more humidifiers at a first set of one or more locations within a space and one or more dehumidifiers at a second set of one or more locations within the space; (2) introducing pollutant trapping material causing its diffusion away from the first set of one or more locations; (3) removing the pollutant trapping material, along with pollutants adhered thereto, from the air by dehumidifying it at the second set of one or more locations; (4) Measuring the pollutant concentration level and relative humidity in the space; (5) If the pollutant values reached/exceeded a first threshold value, boosting [increasing] the rate of dehumidifying the air and thus the amounts of pollutant trapped from the air; (6) Measuring pollutant concentration/density level and relative humidity in the air; and/or (7) if the pollutant value falls back below the first threshold value and the humidity value falls below a second threshold value, lowering the rate of dehumidifying the air, back to its pre-boosted level.

FIG. 2D, is a flowchart showing the main steps executed as part of a third exemplary operation scenario process for conditioning and purifying air, in accordance with some embodiments of the present invention.

The shown process, includes the following system executed steps: (1) Humidifier extracts water into the air; (2) Scrubber “mechanically‘ washes the air and particles therein are collected; (3) Dehumidifier liquid desiccant facilitates the collection of the water in the air and small particles/pollutants attracted/adhered to it; (4) If the air in the space/environment is/became dry to a certain extent, the System Controller boosts the operation of the Humidifier to bring more water into the air; and (5) Dehumidifier liquid desiccant speed/work is enhanced/accelerated/retained due to increase in the relative humidity.

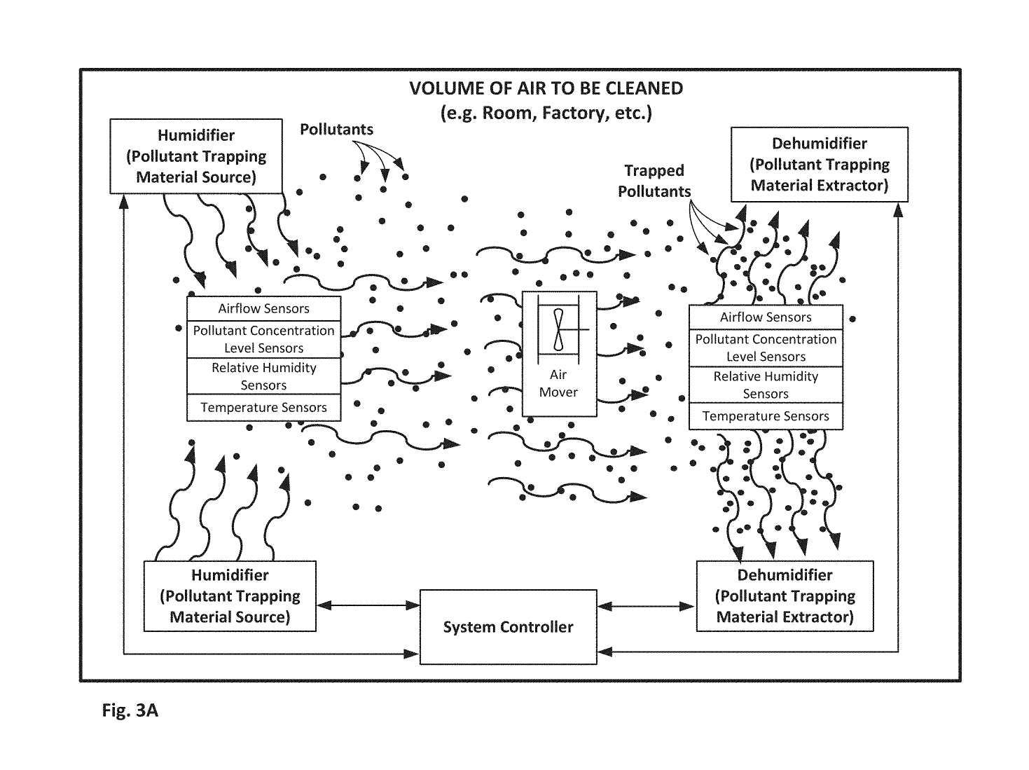

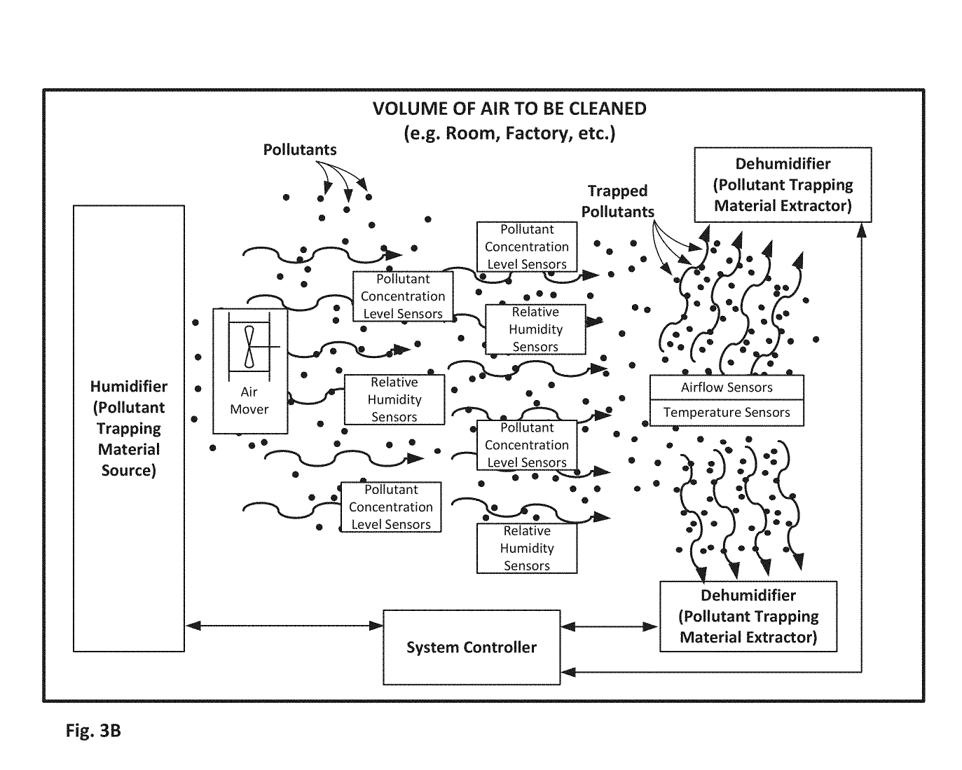

FIG. 3A, there is shown a block diagram providing a schematic view of a first configuration of humidifiers, dehumidifiers, sensors and air movers, in accordance with some embodiments of the present invention.

In the exemplary configuration shown, two humidifiers are positioned at the left side of the space (e.g. room) and two dehumidifiers are positioned on its right side. Two blocks of sensors—each block including: a pollutant level sensor, a humidity sensor, an airflow sensor and a temperature sensor—are positioned within the space being purified/conditioned, one at the left side of the space in proximity to the humidifiers and a second at the right side of the space in proximity to the dehumidifiers. An air mover is positioned substantially at the center of the space.

In FIG. 3B, there is shown a block diagram providing a schematic view of a second configuration of: Humidifiers, Dehumidifiers, Sensors and Air Movers, in accordance with some embodiments of the present invention.

In the exemplary configuration shown, one humidifier is positioned at the left side of the space (e.g. room) and two dehumidifiers are positioned on its right side. An air mover is positioned in proximity to the humidifier; and an air flow sensor and a temperature sensor are positioned in proximity to the dehumidifiers. Pollutant level sensors and humidity sensors are randomly positioned substantially at and around the center of the space.

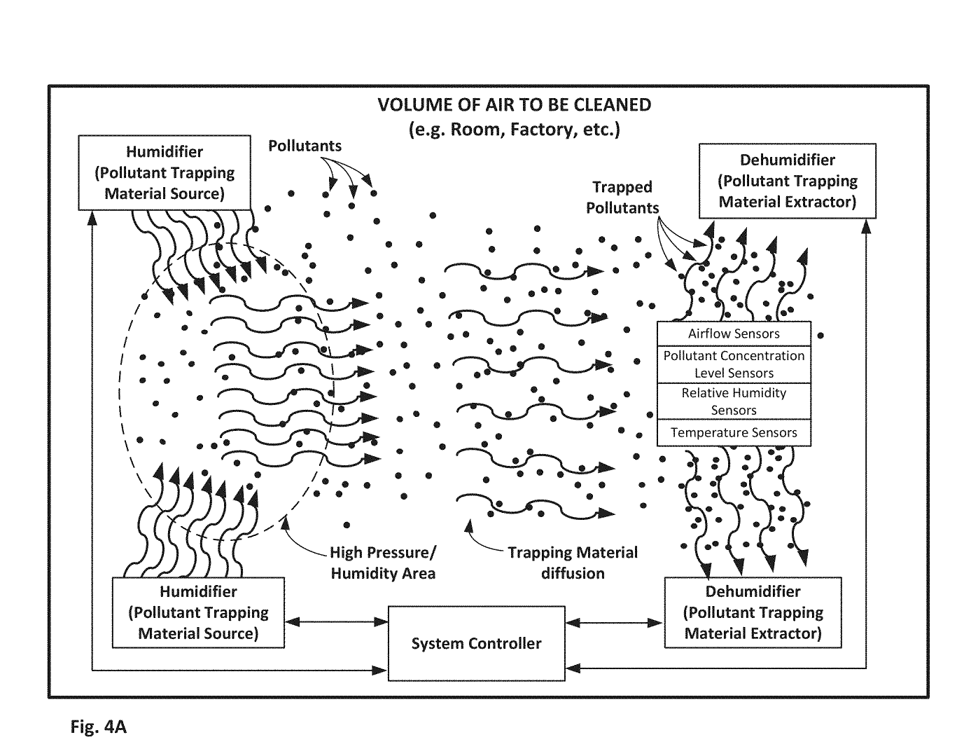

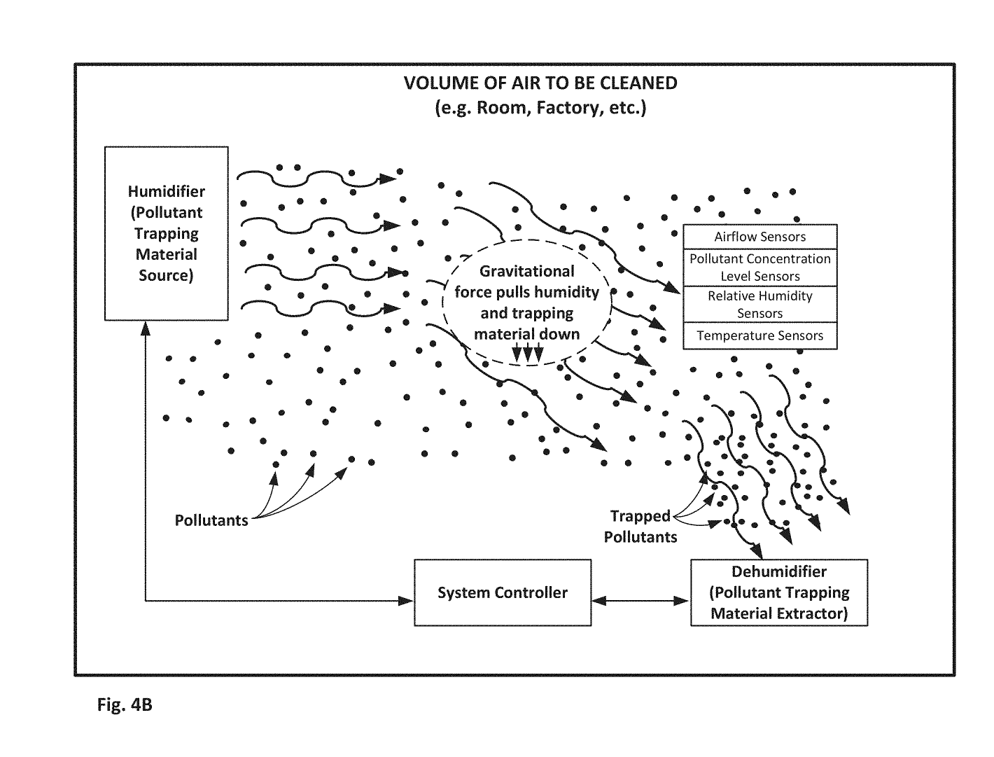

In FIG. 4A, there is shown a block diagram of the main components and layout of an exemplary—diffusion based purification enhancing configuration—of a system for conditioning and purifying air, in accordance with some embodiments of the present invention.

A first humidifier shown at the top left corner of the space, introduces pollutant removing material substantially in a downward direction, whereas a second humidifier shown at the bottom left corner of the space, introduces pollutant removing material substantially in an upward direction. The pollutant removing material flows from each of the two humidifiers, meet, creating an area of substantially high pressures and/or humidity, triggering enhanced diffusion of the pollutant removing material. As the diffusion is limited by the left side (e.g., wall) of the space the pollutant removing material diffuses substantially to the right and towards the shown dehumidifiers, thus enhancing the air purification/conditioning process.

In FIG. 4B, there is shown a block diagram of the main components and layout of an exemplary—gravitational based purification enhancing configuration—of a system for conditioning and purifying air, in accordance with some embodiments of the present invention.

A humidifier shown at the top left corner of the space, introduces pollutant removing material substantially in a horizontal direction. The pollutant removing material flows from the humidifier. As the earth's gravitational force effects it, the flow gradually changes its direction from its initial left to right horizontal movement to a flow directed downward and towards the shown dehumidifier on the bottom left side of the space, thus enhancing the air purification/conditioning process.

According to some embodiments of the present invention, a system for removing pollutants from air within a space, may include: one or more humidifiers, positioned at a first set of one or more locations within the space, for introducing a pollutant trapping material at least partially composed of water (H2O) into the air of the space by evaporating the pollutant trapping material, wherein the pollutant trapping material adheres to pollutants in the air being purified: one or more dehumidifiers, positioned at a second set of one or more locations within the space, for removing the pollutant trapping material, along with pollutants adhered thereto, from the air by dehumidifying it; a control logic for collaborating the cooperation of the humidifier(s) and the dehumidifier(s) at least partially based on the rate or speed at which a combination of the one or more dehumidifiers dehumidify the air.

According to some embodiments, a system for removing pollutants from air within a space, may include: one or more humidifiers, positioned at a first set of one or more locations within the space, for introducing a pollutant trapping material at least partially composed of water (H2O) into the air of the space by evaporating the pollutant trapping material, wherein the pollutant trapping material adheres to pollutants in the air being purified; one or more dehumidifiers, positioned at a second set of one or more locations within the space, for removing the pollutant trapping material, along with pollutants adhered thereto, from the air by dehumidifying it; a control logic for collaborating the cooperation of the humidifier(s) and the dehumidifier(s) such that trapping material along with pollutants adhered thereto moves from the point(s) of introduction towards the point(s) of removal at least partially due to its diffusion and at least partially due to gravity.

According to some embodiments, the system may further include: a first set of sensor(s) for measuring pollutant concentration levels at a third set of one or more locations within the space; a second set of sensor(s) for measuring relative humidity levels at a fourth set of one or more locations within the space; the control logic for collaborating the cooperation of the humidifier(s) and the dehumidifier(s) at least partially based on pollutant concentration level value(s) measured by and received from the first set of sensors and relative humidity level value(s) measured by and received from the second set of sensors.

According to some embodiments, the control logic, upon receipt of: (1) pollutant concentration level value(s) at, or above, a first threshold value and (2) relative humidity level value(s) at, or above, a second threshold value—may boost the operation of the humidifier(s) to a first extent and may boost the operation of the dehumidifier(s) to a second, greater, extent.

According to some embodiments, the position of the humidifiers at the first set of one or more locations within the space, in relation to the position of the dehumidifiers at the second set of one or more locations within the space, may be configured to enhance the gravitational movement of the pollutant trapping material from the point(s) of introduction [by the one or more humidifiers] towards the point(s) of removal [by the one or more dehumidifier(s)].

According to some embodiments, the position of the humidifiers at the first set of one or more locations within the space, in relation to the position of the dehumidifiers at the second set of one or more locations within the space, may be configured to enhance the diffusion of the pollutant trapping material from the point(s) of introduction [by the one or more humidifiers] towards the point(s) of removal [by the one or more dehumidifier(s)].

According to some embodiments, the system may include one or more air movers, functionally connected with the control logic, for enhancing air flow from the proximity of the first set of one or more humidifier locations, where the water based pollutant trapping material is introduced into the air, towards the proximity of the second set of one or more dehumidifier locations, where the water based pollutant trapping material is removed from the air, such that increased amounts of the pollutant trapping material along with pollutants adhered thereto reach the point(s) of removal.

According to some embodiments, the control logic, may boost the operation of the air movers upon: (1) receipt of pollutant concentration level value(s) at, or above, a first threshold value; (2) receipt of relative humidity level value(s) at, or above, a second threshold value; or (3) upon materialization of both (1) and (2).

According to some embodiments, the control logic, may lower [decrease] or may completely halt the operation rate of the humidifier(s) and thus the introduction of pollutant trapping material and humidity into the air, upon: (1) receipt of pollutant concentration level value(s) at, or below, a first threshold value; and (2) receipt of relative humidity level value(s) at, or above, a second threshold value.

According to some embodiments, the control logic, may boost the operation rate of the dehumidifier(s) and thus the amounts of pollutant trapped from the air, upon: (1) receipt of pollutant concentration level value(s) at, or above, a first threshold value; and (2) receipt of relative humidity level value(s) at, or above, a second threshold value.

According to some embodiments, the control logic, may lower the operation rate of the dehumidifiers back to their pre-boosted rate, upon: (1) receipt of pollutant concentration level value(s) below the first threshold value; or (2) receipt of relative humidity level value(s) below the second threshold value.

According to some embodiments, the type of space which air's pollutants are removed by the system may be selected from a group consisting of: (1) a residential space, (2) an office space, (3) an industrial space, (4) the space of a public/entertainment venue, and/or (5) open spaces of parks or cities.

According to some embodiments, the system may further include a reservoir for collecting moisture/water from the air by the dehumidifier(s).

According to some embodiments, the system may further include a filter, positioned between the dehumidifier(s) and the reservoir, for removing adhered air pollutants contamination from the liquid moisture/water collected by the dehumidifier(s).

According to some embodiments, the dehumidifier(s) may utilize a desiccant as a drying agent. According to some embodiments, the desiccant may be a liquid desiccant.

According to some embodiments, the system may further include at least one humidifier actuator, or at least one dehumidifier actuator, or both, for dynamically shifting the positions of one or more of the humidifiers or dehumidifiers, based on signals relayed by and received from the control logic; wherein shifting the positions of the humidifiers or the dehumidifiers affects the pace of the gravitation facilitated movement of the pollutant trapping material from the point(s) of introduction [by the one or more humidifiers] towards the point(s) of removal [by the one or more dehumidifier(s)].

According to some embodiments, the system may further include at least one humidifier actuator, or at least one dehumidifier actuator, or both, for dynamically shifting the positions of one or more of the humidifiers or dehumidifiers, based on signals relayed by and received from the control logic; wherein shifting the positions of the humidifiers or the dehumidifiers affects the pace of the diffusion facilitated movement of the pollutant trapping material from the point(s) of introduction [by the one or more humidifiers] towards the point(s) of removal [by the one or more dehumidifier(s)].

According to some embodiments, a method of removing pollutants from air within a space, may include: positioning one or more humidifiers at a first set of one or more locations within the space and one or more dehumidifiers at a second set of one or more locations within the space; introducing pollutant trapping material at least partially composed of water (H2O) into the air of the space by evaporating and diffusing the pollutant trapping material from the first set of one or more locations within the space, wherein the pollutant trapping material adheres to pollutants in the air being purified; and/or removing the pollutant trapping material, along with pollutants adhered thereto, from the air by dehumidifying it at the second set of one or more locations within the space, wherein the pollutant trapping material along with pollutants adhered thereto moves from the point(s) of introduction towards the point(s) of removal at least partially due to its diffusion and at least partially due to gravity.

According to some embodiments, the method may further include moving air from the proximity of the first set of one or more locations, where the water based pollutant trapping material is introduced into the air, towards the second set of one or more locations where the water based pollutant trapping material is removed from the air, such that increased amounts of the pollutant trapping material along with pollutants adhered thereto reach the point(s) of removal.

According to some embodiments, the method may further include intermittently detecting the concentration of pollutant in the air of the space and boosting [increasing] the rate of introduction of pollutant trapping material into the air upon the concentration of pollutant reaching or exceeding a threshold value.

According to some embodiments, the method may further include: intermittently detecting the relative humidity in the air; boosting [increasing] the rate of dehumidifying the air and thus the amounts of pollutant trapped from the air, upon the concentration of pollutant reaching or exceeding a first threshold value; and/or lowering the rate of dehumidifying the air, back to its pre-boosted level, upon: (1) the concentration of pollutant falling back below the first threshold value and (2) the relative humidity in the air falling below a second threshold value.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for removing pollutants from air within a space, said system including:
one or more humidifiers, positioned at a first set of one or more locations within the space, for introducing a pollutant trapping material at least partially composed of water (H₂O) into the air of the space by evaporating the pollutant trapping material, wherein the pollutant trapping material adheres to pollutants in the air being purified;
one or more dehumidifiers, positioned at a second set of one or more locations within the space, for removing the pollutant trapping material, along with pollutants adhered thereto, from the air by dehumidifying it;
a control logic for collaborating the cooperation of said humidifier(s) and said dehumidifier(s) at least partially based on the rate or speed at which a combination of said one or more dehumidifiers dehumidify the air.

2. A system for removing pollutants from air within a space, said system including:
one or more humidifiers, positioned at a first set of one or more locations within the space, for introducing a pollutant trapping material at least partially composed of water (H₂O) into the air of the space by evaporating the pollutant trapping material, wherein the pollutant trapping material adheres to pollutants in the air being purified;
one or more dehumidifiers, positioned at a second set of one or more locations within the space, for removing the pollutant trapping material, along with pollutants adhered thereto, from the air by dehumidifying it;
a control logic for collaborating the cooperation of said humidifier(s) and said dehumidifier(s) such that trapping material along with pollutants adhered thereto moves from the point(s) of introduction towards the point(s) of removal at least partially due to its diffusion and at least partially due to gravity.

3. The system according to claim I, further including:
a first set of sensor(s) for measuring pollutant concentration levels ata third set of one or more locations within the space;
a second set of sensor(s) for measuring relative humidity levels at a fourth set of one or more locations within the space;
said control logic for collaborating the cooperation of said humidifier(s) and said dehumidifier(s) at least partially based on pollutant concentration level value(s) measured by and received from said first set of sensors and relative humidity level value(s) measured by and received from said second set of sensors.

4. The system according to claim 3, wherein said control logic, upon receipt of: (1) pollutant concentration level value(s) at, or above, a first threshold value and (2) relative humidity level value(s) at, or above, a second threshold value boosts the operation of said humidifier(s) to a first extent and boosts the operation of said dehumidifier(s) to a second, greater, extent.

5. The system according to claim 3, wherein the position of said humidifiers at the first set of one or more locations within the space, in relation to the position of said dehumidifiers at the second set of one or more locations within the space, enhances the gravitational movement of the pollutant trapping material from the point(s) of introduction [by the one or more humidifiers]towards the point(s) of removal [by the one or more dehumidifier(s)].

6. The system according to claim 3, wherein the position of said humidifiers at the first set of one or more locations within the space, in relation to the position of said dehumidifiers at the second set of one or more locations within the space, enhances the diffusion of the pollutant trapping material from the point(s) of introduction [by the one or more humidifiers] towards the point(s) of removal [by the one or more dehumidifier(s)].

7. The system. according to claim 3, further including one or more air movers, functionally connected with said control logic, for enhancing air flow from the proximity of the first set of one or more humidifier locations, where the water based pollutant trapping material is introduced into the air, towards the proximity of the second set of one or more dehumidifier locations, where the water based pollutant trapping material is removed from the air, such that increased amounts of the pollutant trapping material along with pollutants adhered thereto reach the point(s) of removal.

8. The system. according to claim 7, wherein said control logic, boosts the operation of said air movers upon: (1) receipt of pollutant concentration level value(s) at, or above, a first threshold value; (2) receipt of relative humidity level value(s) at, or above, a second threshold value; or (3) upon materialization of both (1) and (2).

9. The system according to claim 3, wherein said control logic, lowers [decreases] or completely halts the operation rate of said humidifier(s) and thus the introduction of pollutant trapping material and humidity into the air, upon: (1) receipt of pollutant concentration level values) at, or below, a first threshold value; and (2) receipt of relative humidity level value(s) at, or above, a second threshold value.

10. The system according to claim 3, wherein said control logic, boosts the operation rate of said dehumidifier(s) and thus the amounts of pollutant trapped from the air, upon: (1) receipt of pollutant concentration level value(s) at, or above, a first threshold value; and (2) receipt of relative humidity level value(s) at, or above, a second threshold value.

11. The system according to claim 10, wherein said control logic, lowers the operation rate of said dehumidifiers back to their pre-boosted rate, upon: (1) receipt of pollutant concentration level value(s) below the first threshold value; or (2) receipt of relative humidity level value(s) below the second threshold value.

12. The system according to claim 3, wherein the type of space which air's pollutants are removed is selected from a group consisting of: (1) a residential space, (2) an office space, (3) an industrial space, (4) the space of a public/entertainment venue, and (5) open spaces of parks or cities.

13. The system according to claim 3, further including a reservoir for collecting moisture/water from the air by said dehumidifier(s).

14. The system according to claim 13, further including a filter, positioned between said dehumidifier(s) and said reservoir, for removing adhered air pollutants contamination from the liquid moisture/water collected by said dehumidifier(s).

15. The system according to claim 3, wherein said dehumidifier(s) utilize a desiccant as a drying agent.

16. The system according to claim 15, wherein the desiccant is a liquid desiccant.

17. A method of removing pollutants from air within a space, said method including:
positioning one or more humidifiers at a first set of one or more locations within the space and one or more dehumidifiers at a second set of one or more locations within the space;
introducing pollutant trapping material at least partially composed of water (H2O) into the air of the space by evaporating and diffusing the pollutant trapping material from the first set of one or more locations within the space, wherein the pollutant trapping material adheres to pollutants in the air being purified; and
removing the pollutant trapping material, along with pollutants adhered thereto, from the air by dehumidifying it at the second set of one or more locations within the space,
wherein the pollutant trapping material along with pollutants adhered thereto moves from the point(s) of introduction towards the point(s) of removal at least partially due to its diffusion and at least partially due to gravity.

18. The method according to claim 17, further including moving air from the proximity of the first set of one or more locations, where the water based pollutant trapping material is introduced into the air, towards the second set of one or more locations where the water based pollutant trapping material is removed from the air, such that increased amounts of the pollutant trapping material along with pollutants adhered thereto reach the point(s) of removal.

19. The method according to claim 18, further including intermittently detecting the concentration of pollutant in the air of the space and boosting [increasing] the rate of introduction of pollutant trapping material into the air upon the concentration of pollutant reaching or exceeding a threshold value.

20. The method according to claim 19, further including:
intermittently detecting the relative humidity in the air:
boosting [increasing] the rate of dehumidifying the air and thus the amounts of pollutant trapped from the air, upon the concentration of pollutant reaching or exceeding a first threshold value; and
lowering the rate of dehumidifying the air, back to its pre-boosted level, upon: (1) the concentration of pollutant falling back below the first threshold value and (2) the relative humidity in the air falling below a. second threshold value.
